(19) United States
(12) Patent Application Publication
(10) Pub. No.: US 2010/0158673 A1
(43) Pub. Date: Jun. 24, 2010

(54) Artificial Tree and Vertical Axis Wind Turbine Combination

(76) Inventor: Gregory Keene, Monsey, NY (US)

Correspondence Address: Law Office of Michael J. Feigin, 103 The Circle, (http://PatentLawNY.com), Passaic, NJ, 07055, US

(21) Appl. No.: 12/715,476

(22) Filed: Mar. 2, 2010

(51) Int. Cl. F03D 9/00; F03D 3/04; A41G 1/00

(52) U.S. Cl. 415/121.3; 428/18

(57) ABSTRACT

Embodiments of the disclosed technology comprise a vertical axis wind turbine with a generally cylindrical encasement or housing enclosing a portal opening into rotating cups (turbine blades), connected to a central spindle (turbine shaft), for electricity generation. A plurality of branches covering and spaced around a horizontal axis of, and attached to, the generally cylindrical encasement help hide the device from a casual viewer, and angled vanes at either side of the portal direct wind into the portal for greater efficiency.

### FIELD OF THE DISCLOSED TECHNOLOGY

The disclosed technology relates generally to power generation from wind, and more particularly, to vertical axis wind turbines.

### BACKGROUND OF THE DISCLOSED TECHNOLOGY

The energy industry is always looking for ways to increase the intake of energy from alternative sources which cause less harm to the environment. One of the most promising alternative energy resources is wind energy, where the kinetic energy of wind is converted into electrical energy by strategically placed wind turbines. The most common turbines are the horizontal-axis wind turbines (HAWT). These turbines require high placement in the air where wind speeds are highest. However, in many places, this creates an unpleasant view and often obstructs a naturally beautiful skyline. Many urban/suburban residential and commercial areas, while having sufficient winds are zoned no wind turbines and even the smallest HAWT are not permitted. Alternatively, vertical axis wind turbines (VAWTs) are often closer to the ground than HAWTs, but still provide a conspicuous image and are similarly not permitted. Furthermore, a HAWT is much less effective at converting wind energy to electrical energy than a VAWT.

There is a need in the art for wind energy converters that are visually neutral that blend into the natural environment by being inconspicuous. This would result in the allowance of wind turbines in areas that are zoned no wind turbines and in pristine wilderness areas where wind potential is often the greatest. More electrical energy produced from wind energy would be created. This, in turn, would result in less dependency on non-renewable resources. Furthermore, since wind power does not create any air pollution, such as green house gases, the utilization of more wind turbines would result in a decrease in the future rate of air pollution.

### SUMMARY OF THE DISCLOSED TECHNOLOGY

An object of the disclosed technology is to offer a vertical-axis wind turbine that is visually neutral, inconspicuous and highly efficient at converting wind energy to electrical energy.

More specifically, an object of the disclosed technology is a vertical-axis turbine that is characterized to look like a natural object (e.g., a pine tree, a palm tree, etc.) and encloses a turbine to cut down counterproductive wind resistance, resulting in a more productive wind energy conversion.

An embodiment of the disclosed technology is a vertical axis wind turbine (VAWT) that is within in a generally cylindrical (that is, fully cylindrical, having a conical upper portion and cylindrical lower portion, etc.) enclosure. The generally cylindrical encasement has a first and a second side (when split along an imaginary vertical plane). The first side comprises an opening to the vertical-axis wind turbine, whereas the second side is closed and blocks wind. The opening of the first side is between 50% and 90% of a vertical length (a height) of the generally cylindrical encasement. Furthermore, an embodiment of the disclosed technology comprises a plurality of grates fixedly attached to the cylindrical encasement, where each grate partially covers the opening. In embodiments of the disclosed technology, a wire mesh covers the outside of the grates.

Furthermore, a vertical axis wind turbine of the disclosed technology may comprise a plurality of branches covering (at least 50%) and densely spaced around a horizontal axis of the generally cylindrical encasement, for example, so as to resemble a row of branches on a pine tree, a palm tree, etc. In embodiments disclosed, the encasement may further have ornamental elements resembling natural objects (e.g., leaves, branches, bark etc.).

In the technology disclosed, the vertical axis wind turbine may further have a motorized component (such as a yaw drive) that rotates the cylindrical encasement relative to the ground. Furthermore, in an embodiment of the disclosed technology, the motorized component is configured to rotate a vertical edge of the opening to a position facing into an incoming wind; while the support structure of the encasement remains stationary (this will become clearer in the detailed description below). This results in a portion of the wind being able to directly enter and exit the cylindrical encasement.

In an embodiment of the technology disclosed, the vertical-axis wind turbine comprises a wind deflection vane attached to the opening at an obtuse angle, so as to direct wind into the opening. “Attached to the opening” is defined as having a closest part being no greater than 5 degrees distant from the opening, around the generally cylindrical encasement. Furthermore, two vanes can be attached to an opening, one to a left side of the opening and the other to a right side of an opening.

A second embodiment of the disclosed technology is an artificial tree comprising an encasement with a conical portion. The artificial tree has a vertical-axis wind turbine, where the encasement has both an open and a closed portion, the open portion having a left and a right side. Furthermore, in an embodiment disclosed, a vertical length (the height) of the open portion is between 50% and 90% of the height of the artificial tree. This embodiment of the disclosed technology has at least one vane attached to a side of the open portion at an obtuse angle relative to the opening. In an embodiment disclosed, there may be two vanes, one vane being attached to the left side of the open portion and the other to the right side of the open portion.

In embodiments of the disclosed technology, a plurality of artificial tree parts is fixedly attached to the encasement. The artificial tree parts may be artificial tree branches and/or artificial tree bark. The artificial tree may resemble a palm tree, a pine tree, or the like. A grate may be fixedly attached to, and covering a part of, the open portion.

The artificial tree may be configured to rotate around a vertical axis (which may be by way of a motorized component such as a rotor or motor) relative to the support structure of the artificial tree. The open portion may be configured to rotate such that an edge of the opening is either positioned directly into or perpendicularly to the oncoming wind.

Further details are set forth in the detailed description below.

### BRIEF DESCRIPTION OF THE DRAWINGS

FIG. 1 shows an elevation view of an artificial tree/vertical axis wind turbine of embodiments of the disclosed technology.

FIG. 2 shows a portion of the vertical axis wind turbine and a cutaway of a support base of an embodiment of the disclosed technology.

FIG. 3 shows a wind vane wind indicator attached to the top of a vertical branch used in embodiments of the disclosed technology.

FIG. 4 shows a detail of the interior of a support base used in embodiments of the disclosed technology.

FIG. 5 shows a diagrammatic cross-sectional view of a cylinder, wind deflection vanes, and portal of embodiments of the disclosed technology along section line A-A of FIG. 2.

FIG. 6 shows a perspective diagrammatic view of an embodiment of the disclosed technology.

FIG. 7 shows a diagrammatic view of air flow through the turbine blades of the device shown in FIG. 6.

FIG. 8 shows an off the ground embodiment of the disclosed technology.

FIG. 9 shows the top portion of the off-the-ground embodiment of FIG. 8 in greater detail.

FIG. 10 shows a perspective close-up view of the device shown in FIGS. 8 and 9 of embodiments of the disclosed technology.

### DETAILED DESCRIPTION OF EMBODIMENTS OF THE DISCLOSED TECHNOLOGY

Embodiments of the disclosed technology comprise a vertical axis wind turbine with a generally cylindrical encasement or housing enclosing a portal opening into rotating turbine blades connected to a central turbine shaft for electricity generation. A plurality of branches covering and spaced around a horizontal axis of, and attached to, the generally cylindrical encasement helps hide the device from a casual viewer, and angled vanes at either side of the portal to direct wind into the portal for greater turbine efficiency.

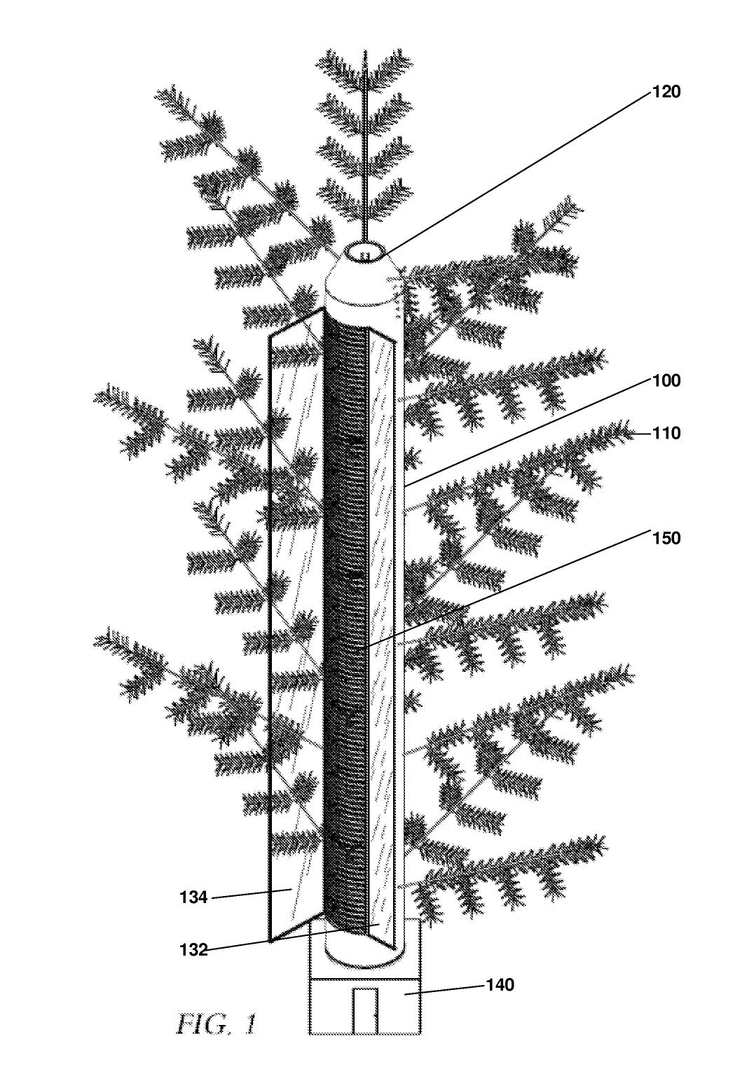

FIG. 1 shows an elevation view of an artificial tree/vertical axis wind turbine of embodiments of the disclosed technology. A cylindrical housing or encasement 100 houses a vertical axis wind turbine (VAWT) therein. Branches 110 or other decorations are used to disguise the VAWT. In the embodiment shown in FIG. 1, the branches resemble artificial pine tree branches and leaves. Vanes 132 and 134 open out on one side of the cylindrical housing 100 with a portal there-between for wind to enter. Wind may exit via one or both of the portals or a cap/cone 120, the cap/cone 120 being positioned at a top of the cylindrical housing 100. Further branches 110 may protrude from the cap/cone 120. The vanes 132 and 134 are made from any resilient transparent material, such as poly(methyl methacrylate) or acrylic. They vanes are attached to either side of the portal to help direct wind intake into the VAWT. Grates 150 are generally equidistantly spaced apart, when used, and partially cover the portal, so as to allow air to flow through but prevent a viewer from seeing the turbine blades inside. A wire mesh (e.g. chicken wire material) covers the outside of the grate, in an embodiment of the disclosed technology, and prevents the entrance of birds, debris, and so forth.

Beneath cylindrical housing 100 is a support base 140 which supports the tree portion (the cylindrical housing, VAWT, and decorations such as branches) and, in embodiments of the disclosed technology, comprises a generator, gears, transformers, controller, and other electromechanical equipment used to generate electricity. Still further, the tree portion is rotatable with respect to the support base 140, so that the edge of the portal/opening to the VAWT is constantly facing towards, or at a right angle to, the wind. The tree portion may rotate up to 360 degrees with respect to the support structure 140.

Referring again to the cap/cone 120, a single branch 110 juts out of the cap/cone vertically, in embodiments of the disclosed technology, and connected to its top is a wind vane or wind indicator. This device detects the direction of the wind and sends such information electronically to a control unit within the support base 140. Using such data, the control unit determines the direction of the wind and the tree portion is rotated into a direction of the wind to ensure optimal power generation.

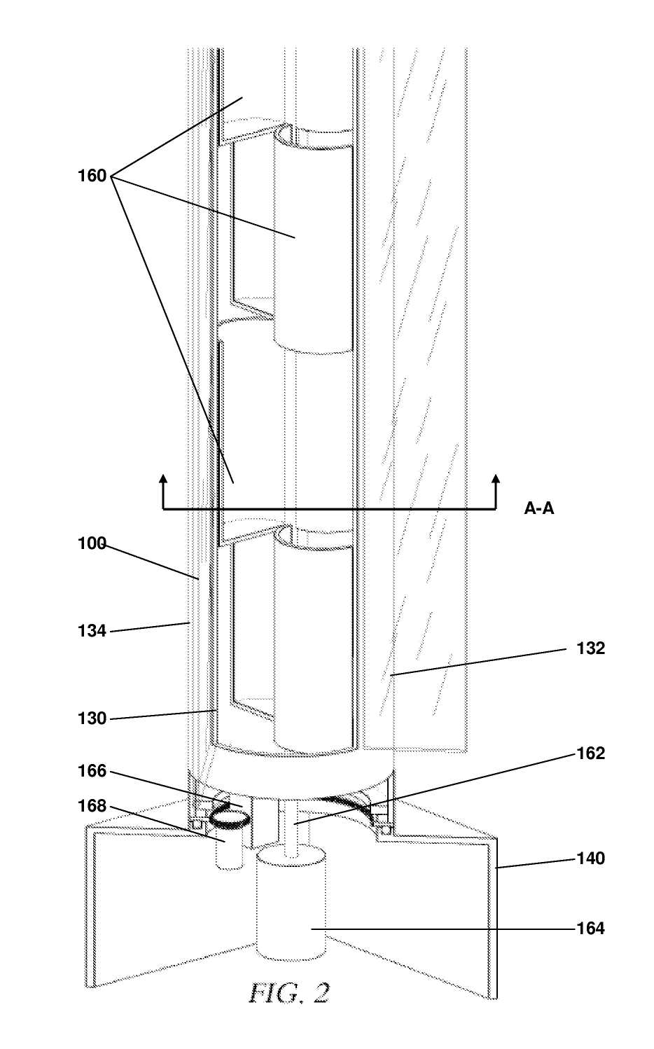

FIG. 2 shows a portion of the vertical axis wind turbine and a cutaway of a support base of an embodiment of the disclosed technology. As is more clearly shown in this Figure than previously, the vane 132, in embodiments of the disclosed technology, is at an obtuse angle to the portal 130, and the vane 134 is at an acute angle to the portal. Each vane may be on either the left or the right side. In embodiments of the disclosed technology, a generally long, flat side of an acute-angled vane (with respect to the portal opening 130) faces into the wind, while a narrow leading edge of the other vane faces into the wind. In this manner, the wind is led into the concave portion of the turbine blades 160

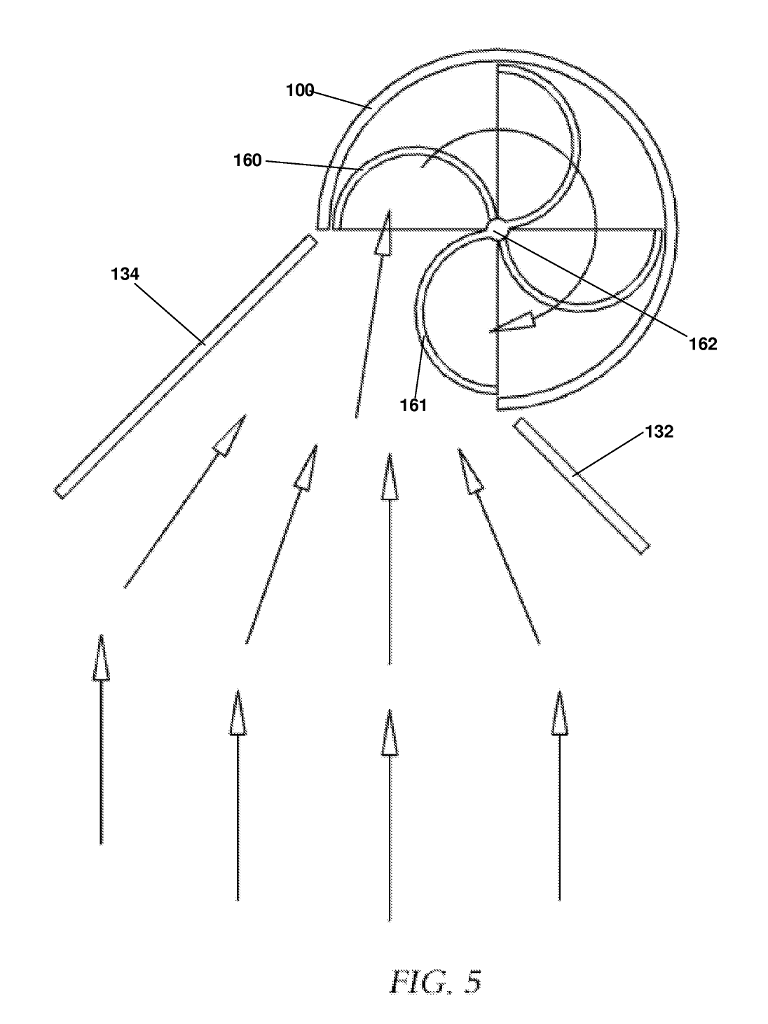

The turbine blades, as shown in the figure, are spaced around a central turbine shaft 162 with a concave and a convex side thereof. The turbine blades are half cylinders, cut vertically, in embodiments of the disclosed technology. They may also be planar or have varying degrees of concavity/convexity. The turbine shaft 162 passes through or terminates at a generator 164 where rotational energy is converted into electrical energy. A controller 166 receives data from a wind vane or wind indicator (a device known in the art which detects the direction of the wind) and activates motor 168, as necessary, which is engaged via gears with the cylindrical housing 100. Upon receiving a signal from a wind vane or wind indicator indicating that the wind, for at least a pre-designated threshold period of time and/or pre-designated threshold of velocity is coming from a certain direction (within a pre-defined tolerance level, such as maintaining a velocity within 10 degree range of origin), the control unit 166 instructs the motor 168 to rotate the cylindrical housing 100, such that the right edge of the portal 130 or a vane 134 is facing towards the wind, again, within an acceptable tolerance level, such as within 10 degrees or 15 degrees of the average incoming wind direction. The elements of the support base 140 are described in further detail with reference to FIG. 4, below.

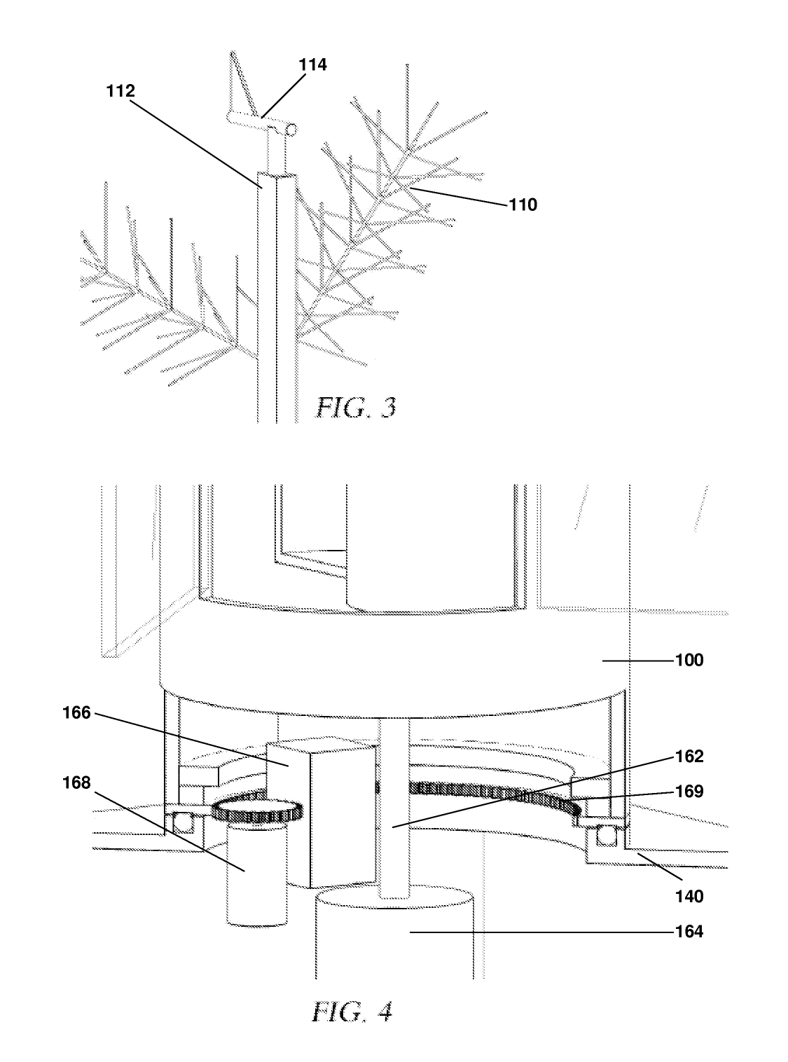

FIG. 3 shows a wind vane attached to the top of a vertical branch used in embodiments of the disclosed technology. The vertical branch 112 is one of the branches 110 of the device. Attached to the to of the vertical branch 112, in embodiments of the disclosed technology, is a wind vane 114 or other wind direction measuring device or indicator which provides data regarding the present direction of the wind. These data are used by a control unit 166 to determine the orientation of the portal, vanes, and cylindrical housing, as will be described in further detail below with respect to FIG. 4.

FIG. 4 shows a detail of the interior of a support base used in embodiments of the disclosed technology. The yaw motor 168 is fixed or attached to the support base 140 or the ground. The yaw motor 168 is engaged with a gear which is, in turn, engaged with teeth 169 positioned on the interior of the cylindrical housing 100. When the controller or control unit 166 receives a signal from, for example, the wind vane 114 indicating a new general direction of the wind for a period of time from a certain direction over a threshold part of that period of time, the yaw motor 168 is engaged to rotate the cylindrical housing 100 for optimal spinning of the turbine shaft 162 and, ultimately, generation of electricity at the generator 164. Referring now to the controller 166, the controller is electrically connected to the yaw motor 168 and sends electrical signals to the yaw motor, causing/instructing the gear to turn clockwise or counterclockwise. Positioning and/or stop instructions may also be sent (or the power to the motor cut) locally or remotely. The cylinder 100 may sit on ball bearings to allow easy rotation around the support base 140.

FIG. 5 shows a diagrammatic cross-sectional view of a cylinder, vanes, and portal of embodiments of the disclosed technology along section line A-A of FIG. 2. The vanes 132 and 134 direct air currents (represented by the elongated arrows with white heads) through a portal of and into the interior of a cylindrical housing 100. The vane 132 is at an obtuse angle with respect to the portal or acute angle with respect to the cylinder 100 (e.g., it faces away from the opening into the cylinder). The vane 134 may be the same size or longer than the vane 132 and extends at an acute angle outwards from an edge of the portal, or an obtuse angle with respect to the cylinder 100. In this manner, when the portal is facing towards the wind, air currents or wind are concentrated before entering the turbine and then push into the concave portion of a turbine blade 160. The air/wind currents push the turbine blades with turbine shaft 162 in a clockwise direction, relative to the orientation shown in FIG. 5. The air exits through a top vent, rear vent, or the portal shown in FIG. 5 between the two vanes 132 and 134. The rotational energy of the turbine shaft is converted into electrical energy via an attached generator.

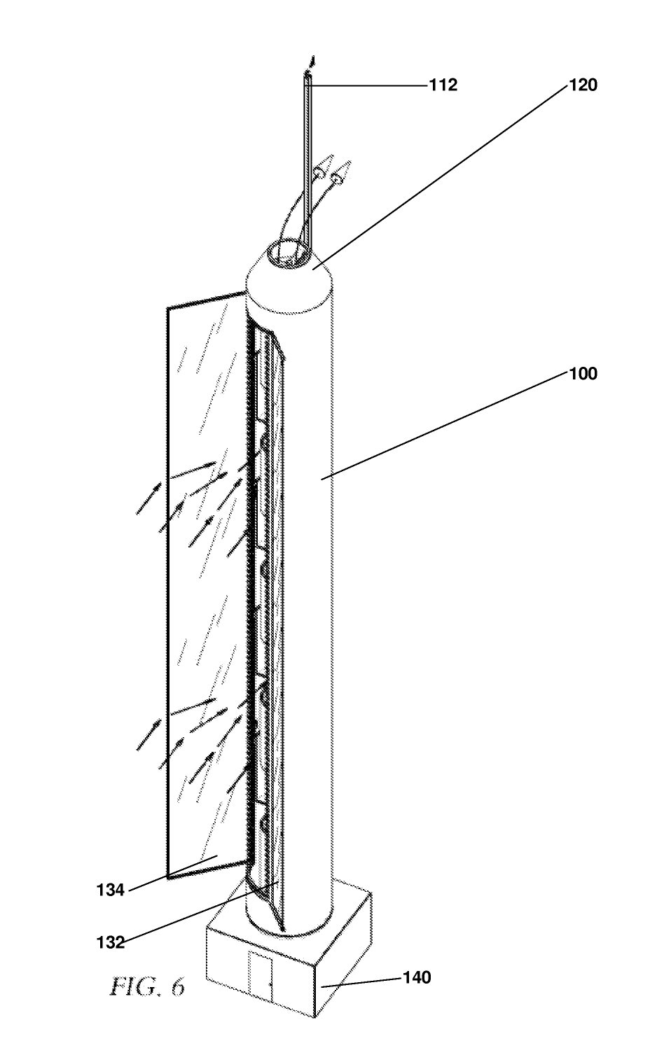

FIG. 6 shows a perspective diagrammatic view of an embodiment of the disclosed technology. Cap 120 comprises a vent out of which air flows (as designated by the two arrows indicating air flow). A wind indicator 112 extends vertically from the cap 120 or cylinder 100. Each of the wind indicator 112, cap, and cylinder 100 may further comprise branches or other decorations which are not shown in this figure/embodiment. Air flows in between the vanes 132 and 134, rotates the turbine blades around the turbine shaft, and exits out through the top of the device, at the vent in the cap 120. As is shown by the length of the arrows indicating relative velocity, when the air is funneled between the vanes and into the cylinder, due to the Venturi effect, the velocity increases for a maximal gain in kinetic energy causing a higher rate of rotation of the turbine shaft.

Referring now to FIGS. 4, 5 and 6, in embodiments of the disclosed technology, an electrical wire passes through a central area of the turbine shaft 162, such as a hollow center. These wires connect a wind vane or wind indicator 114 to the controller 166. As the cylindrical housing 100 may turn relative to the base 140, the center region inside the turbine shaft may remain stationary with respect to the base 140, while the cylindrical housing 100 rotates. In embodiments of the disclosed technology, the top of the cylindrical housing 100 has a crossbeam with portal for the turbine shaft 162 to pass through. This cross beams supports the turbine shaft in place and, further, a wire may pass through. In another embodiment of the disclosed technology, wind direction signals are transmitted to the controller via wires extending through the inside of the tree cylinder and exiting through a slip ring situated between the cylinder and generator. Further points within the cylindrical housing 100 may have crossbeam supports, such as at a halfway point, or equidistantly spaced there-through for support.

The cylinder may reach heights of fifty feet or more, and the added support there-through is necessary in embodiments, depending on height and material used. A diameter-to-height ratio of the generally cylindrical encasement is between 1:9 and 1:20, inclusive, in embodiments of the disclosed technology. While the cylindrical portion may have a tapered top region or may terminate in a tapered cone, for purposes of this disclosure this is referred to as the cylindrical region, that is, any portion of it which has a circular cross section (within an acceptable tolerance level in the industry) is considered part of a generally cylindrical region.

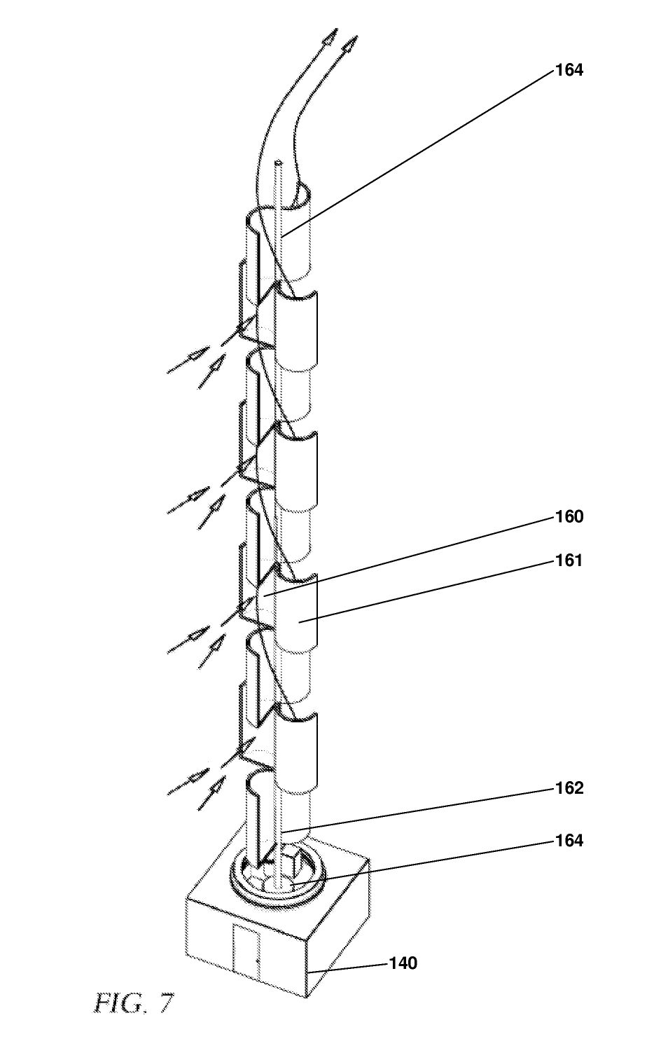

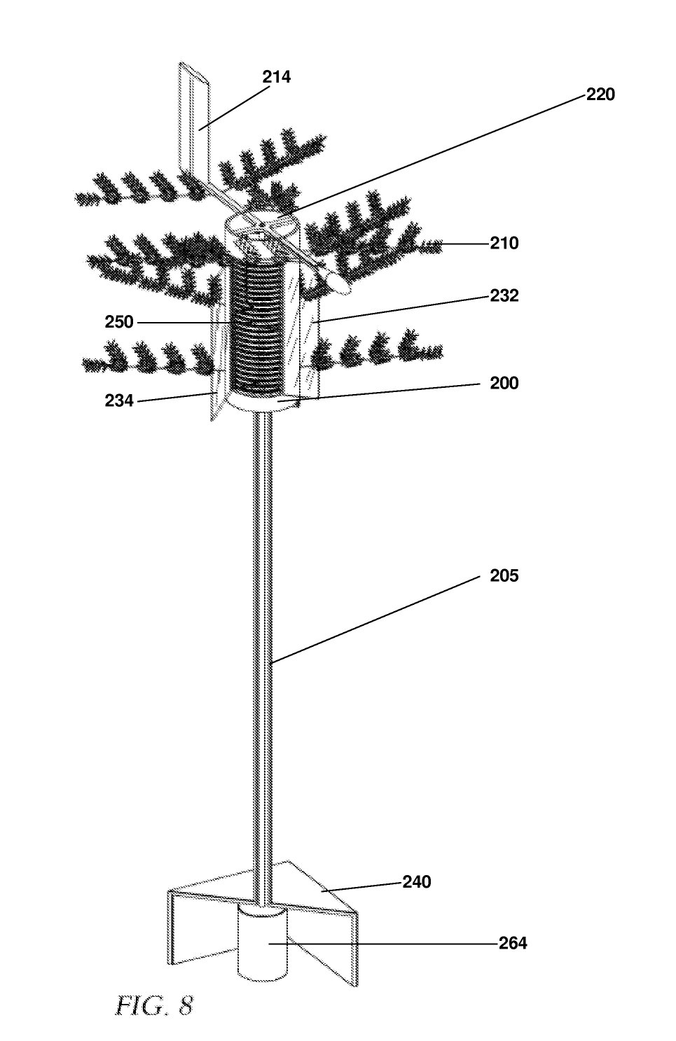

FIG. 7 shows a diagrammatic view of air flow through the turbine blades of the device shown in FIG. 6. The tree branches/decoration, cylindrical housing, and vanes are not shown. The bottom of the turbine shaft 162 connects to the electricity generator 164, which may be located in the support base 140. Arrows indicate direction of wind/air flow. As can be seen in the figure, air enters mainly or only in a direction of flow towards the concave region of a series of turbine blades. The cylindrical housing, with an opening of between 75 and 120 degrees, such as exactly 90 degrees (within an acceptable tolerance level known in the art), prevents wind from hitting the back side of the turbine blades, which would decrease efficiency, as such flow would be working against the flow into the concave portion of the turbine blades 160.

As the air flows into the concave portion of the turbine blades, it causes them to rotate (clockwise, in the configuration / orientation shown in the figure) and the next set of concave regions of turbine blades 161 are pushed by incoming wind. In this manner, the turbine blades rotate around the turbine shaft 162. While 100% efficiency is impossible, the device is designed such that most of the air exits through a pass of least resistance, an exit vent. Here, the exit vent in cap 120 (refer to FIG. 6) is the path of least resistance. A low pressure zone is formed at this exit vent and the air flowing into the concave region of cups 160 and 161 is pulled upwards and out of the vent as it spins around, with new air entering through the portal to continuously push the turbine blades around.

FIG. 8 shows an off the ground embodiment of the disclosed technology. Elements of FIGS. 1-7 have been incremented by 100 in FIG. 8. The design of this embodiment may more resemble a palm or pine tree with a long trunk and branches near the top, while the previous embodiment may more resemble an evergreen tree with branches from top to bottom. Again, the generator is located within a support base 240; however a turbine shaft (not shown) extends through an elongated circular support structure resembling a tree trunk 205 and into the cylindrical housing 200. The cylindrical housing 200 comprises a portal which is covered by grates 250. Vanes 232 and 234 extend outwards from the portal, in embodiments of the disclosed technology, and branches 210 or other decorations to disguise the device as a tree are also present in embodiments of the disclosed technology, as well as artificial tree bark to disguise the elongated support structure 205.

A large wind vane constructed of transparent material 214 is situated at the top of the device in embodiments of the disclosed technology, such as on or connected to a cap 220 with horizontal crossbeam support, as shown in the figure. Because of its smaller size, the off ground version is more efficiently controlled with a large wind vane than with a yaw motor/controller/wind indicator/wires etc. The large wind vane 214 directly turns the circular housing so that the portal faces into the wind for maximal wind entering between the grates 250, covering the portal, and into a central region thereof. Such a portal may be an open section of the circular housing 200 covering 90 degrees. In another embodiment, the electricity generator 264 may be located in or just under the cylindrical housing 200, and a wire through a shaft of the support structure 205 transmits electric current to another device for storage or usage.

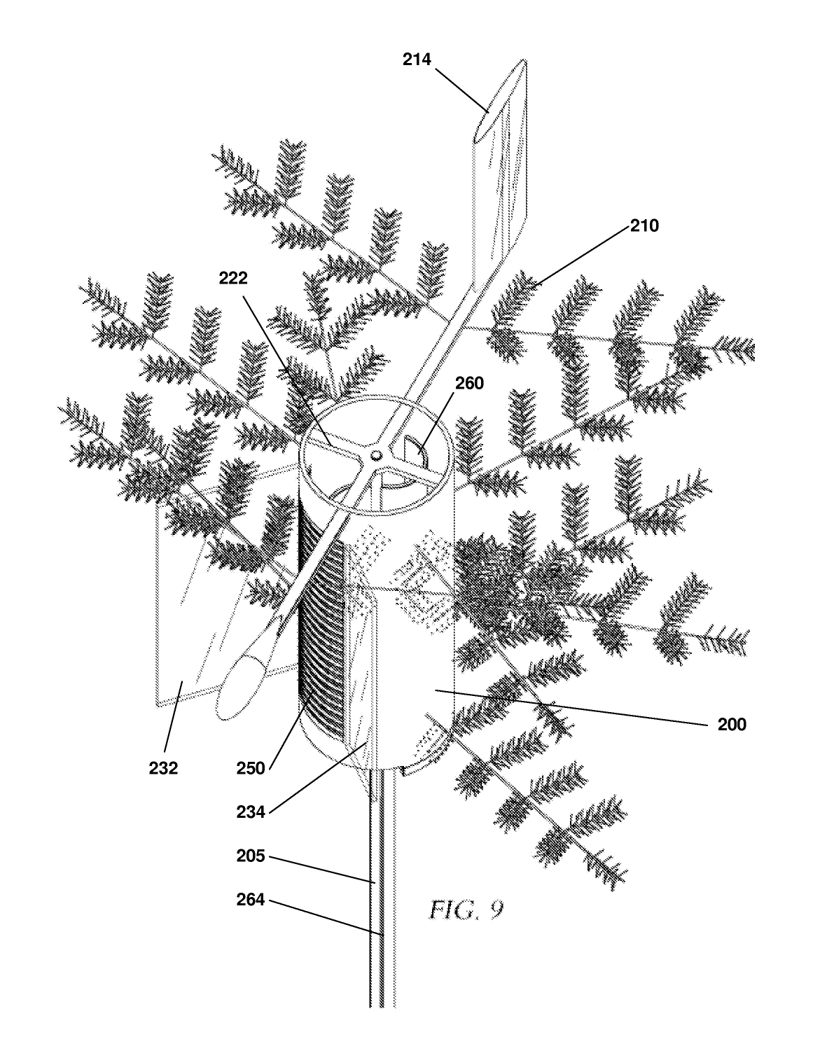

FIG. 9 shows the top portion of the off-the-ground embodiment of FIG. 8 in greater detail. Here, the crossbeam 222 helping support the structural integrity of the generally cylindrical housing 200 is seen at the location of the vent of the top of cylindrical housing. Underneath the crossbeam and wind indicator 214 are the turbine blades 260. The grates 250 completely cover (with spaces between for air) the portal where wind enters. Inside the support structure 205 (shown in cross section) is the turbine shaft 264. Alternatively, a cable or wire for transmitting electrical current may be situated in the support structure 205.

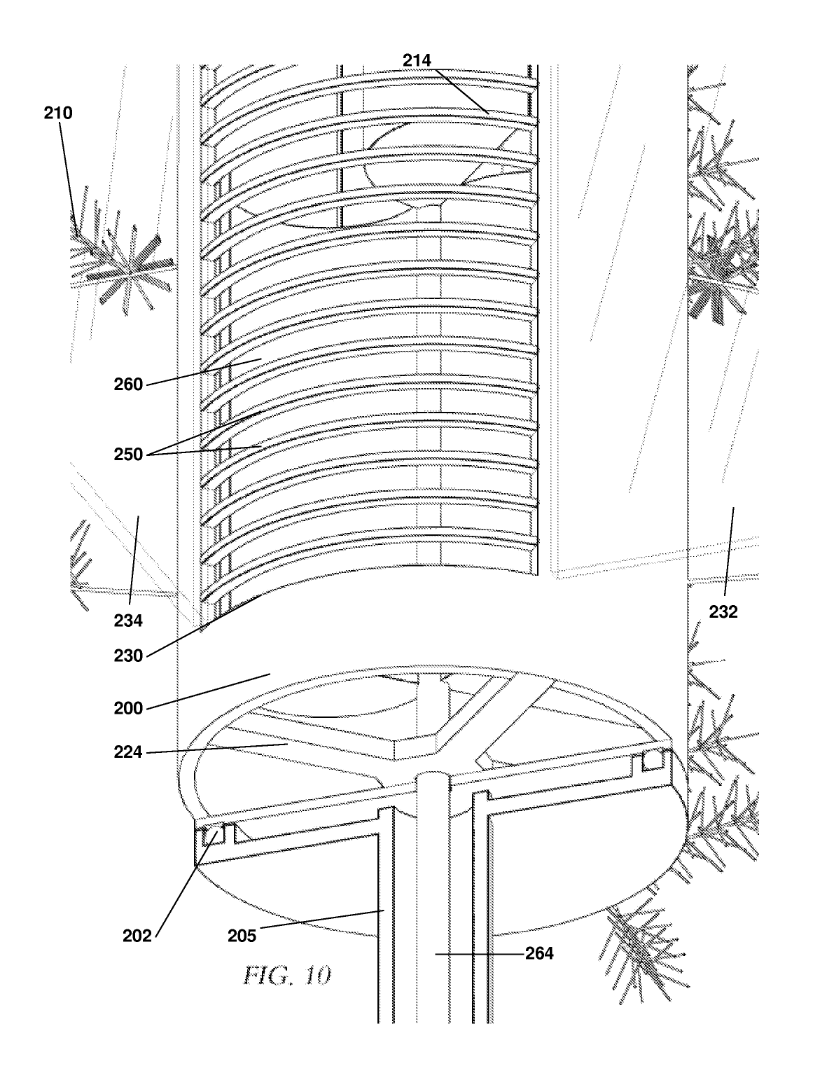

FIG. 10 shows a perspective close-up view of the device shown in FIGS. 8 and 9 of embodiments of the disclosed technology. Here, the cylindrical housing 200 is seen supported by ball bearings 202, so that the housing may rotate above the elongated support 205, which has within it the turbine shaft 264. The turbine shaft 264 is engaged with the turbine blades 260 within the cylindrical housing 200. A portal 230 covering 90 degrees of the cylindrical housing (when measuring a horizontal cross section thereof) is covered with spaced apart grates 250 which allow for air flow there-between. Crossbeams 224 add structural integrity to the cylindrical housing 200 while allowing the turbine shaft to pass through. Branches 210 when densely spaced provide camouflage for the device to make it look like an ordinary tree and unnoticeable to a casual observer, so that such devices may be placed by it self or alongside and above real natural trees. Vanes 232 and 234, as shown here, are transparent, so the branches and leaves can be seen through vanes as to be less conspicuous.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

1. A vertical axis wind turbine comprising:
a generally cylindrical encasement enclosing said vertical axis wind turbine where a first side of said generally cylindrical encasement comprises a portal to said vertical axis wind turbine and a second side of said generally cylindrical encasement is closed; and
a plurality of branches covering and spaced around a horizontal axis of, and attached to, said generally cylindrical encasement.

2. The vertical axis wind turbine of claim 1, where said first side of said cylindrical encasement comprises a plurality of horizontal grates fixedly attached to said encasement and each said horizontal grate of said plurality partially covers said portal.

3. The vertical axis wind turbine of claim 1, wherein a diameter to height ratio of said generally cylindrical encasement is between 1:9 and 1:20, inclusive.

4. The vertical axis wind turbine of claim 3, further comprising a motorized component that rotates said generally cylindrical encasement relative to the ground.

5. The vertical axis wind turbine of claim 4, wherein said vertical length of said portal is configured to rotate an edge of said portal perpendicular to a direction of an incoming wind and a remaining portion of said generally cylindrical encasement is configured to remain stationary relative to the ground.

6. The vertical axis wind turbine of claim 1, where said generally cylindrical encasement is conical.

7. The vertical axis wind turbine of claim 1, where said encasement comprises ornamental elements resembling natural objects.

8. The vertical axis wind turbine of claim 7, where said branches resemble tree branches.

9. The vertical axis wind turbine of claim 1, where said portal comprises a left and a right side, and said vertical axis wind turbine further comprises a vane attached to a side of said portal at an obtuse angle to said portal.

10. The vertical axis of wind turbine of claim 9, comprising two vanes each respectively attached to a left and right side of said portal.

11. An artificial tree comprising:
an encasement comprising a conical portion thereof, said encasement comprising a vertical axis wind turbine therein;
an open portion and a closed portion of said encasement, where said open portion comprises a left and a right side;
at least one vane, attached to a side of said open portion at an obtuse angle to said open portion; and
a plurality of artificial tree parts fixedly attached to said encasement.

12. The artificial tree of claim 11, where said encasement comprises a grate fixedly attached to and covering part of said open portion.

13. The artificial tree of claim 11, where said artificial tree parts comprise artificial tree branches.

14. The artificial tree of claim 13, where said artificial tree parts comprises artificial tree bark.

15. The artificial tree of claim 11, where said at least one vane is two vanes and one said vane is attached to said left side of said open portion and one said vane is attached to a right side of said open portion.

16. The artificial tree of claim 11, wherein a diameter to height ratio of said encasement is between 1:9 and 1:20, inclusive, where said diameter is an average diameter.

17. The artificial tree of claim 11, where said open portion rotates horizontally relative to said artificial tree and said open portion is configured to rotate such that an edge of said portal is positioned directly into oncoming wind.

18. The artificial tree of claim 17, where said open portion rotates by means of a motorized component.

19. The artificial tree of claim 11, where said artificial tree resembles a palm tree.

20. The artificial tree of claim 11, where said artificial tree resembles a pine tree.
